(19) United States
(12) Patent Application Publication
(10) Pub. No.: US 2020/0327502 A1
(43) Pub. Date: Oct. 15, 2020

(54) Project Management Method

(71) Applicant: David & Raymond Patent Firm, Monterey Park, CA (US)

(72) Inventors: Raymond Y. CHAN, Monterey Park, CA (US); Rihui CHEN, Shenzhen (CN); Xueguang DONG, Shenzhen (CN); Tiaowan LIU, Shenzhen (CN); Wei DU, Shenzhen (CN); Xiaoxiao DUAN, Shenzhen (CN)

(21) Appl. No.: 16/796,916

(22) Filed: Feb. 20, 2020

(30) Foreign Application Priority Data
Feb. 20, 2019 (CN) 2019101279062

(51) Int. Cl. G06Q 10/10; G06Q 10/06; G06Q 50/18

(52) U.S. Cl. CPC G06Q 10/103; G06Q 10/06315; G06Q 10/06314; G06Q 10/06313; G06Q 50/184; G06Q 10/1091; G06Q 10/06398; G06Q 10/1097; G06Q 10/063114; G06Q 10/06316

(57) ABSTRACT

The present invention provides a project management method, which comprises the steps of: (A) analyzing a resource demand of the project according to a project view of at least a project; (B) analyzing an available time of the resources according to a resource view of at least a resource; (C) calling the resources to the project according to the resource demand and the available time of the resources.

### CROSS REFERENCE OF RELATED APPLICATION

This is a non-provisional application that claims the benefit of priority under 35 U.S.C. § 119 to a Chinese application, Chinese application number 2019101279062, filed Feb. 20, 2019.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to the field of intellectual property rights, and more particularly to a project management method.

### Description of Related Arts

In the intellectual property rights industry, utilizing computerized technology in administration management is not a common practice. Internal affair management of an intellectual property rights business usually involves complex processes and many objects. Intellectual property rights include patent, trademark, copyright, and trade secret. Different types of intellectual property rights involve different application manners, documents, and procedures, so that the internal case handling processes of the business have to be adapted to various manners of these different types of intellectual property rights as well. When an intellectual property rights business is handling the intellectual property rights application case of a client, it has to follow different procedures according to the type of the intellectual property rights.

In addition, the participants change in various procedures. For example, a patent case requires a writing engineer and a graphic engineer to handle and process it, so as for producing the application documents. A trademark case requires client service personnel to prepare relative trademark application documents. A copyright case requires another application documents to be prepared. Finally, all these application documents have to be submitted by a process manager. In this process, roles of the participants are diverse. They are delicately divided in their works and bearing different responsibilities respectively. Meanwhile, these roles also have to be coordinated in the process. Like patent application, it has to wait until the writing engineer finished the composition, so as to obtain application documents to submit. Hence, the coordination and cooperation among the roles are critical.

Furthermore, deadline is extremely important in the field of intellectual property rights. Delay of a case processing can affect the validity of the intellectual property rights of the client. For example, patent application needs favorable filing date. Therefore, handling efficiency of the case is very significant. The handling efficiency of the roles and the coordination among different roles in the processes are extremely critical factors to the overall handling efficiency.

In addition, when conducting intellectual property rights planning based on the needs of the client, there will be diverse types and quantities of cases. It has to consider the handling ability among various roles, their current conditions, and many other factors at the same time in order to coordinate and manage these cases of different types and quantities by arranging suitable characters to accomplish the processing of the client's cases on time.

Data of the participants involving in the entire process have to be acquired and digested by relative personnel under conventional management technology. In such cases, the data are usually inaccurate and unable to be updated in a real time manner. Unfortunately, inaccurate data of the participants will impede assigning of suitable participant to handle the case, which will then affect the overall coordination and efficiency.

### SUMMARY OF THE PRESENT INVENTION

An advantage of the present invention is to provide a project management method, wherein the project management method helps to computerize the project management of intellectual property rights and enhance the managerial efficiency.

Another advantage of the present invention is to provide a project management method, wherein the project management method has a project view be built for at least a project, which adds the data of the project into the project view, such that the project view can receive various data required for managing the project, so as for achieving highly efficient and accurate management to the project.

Another advantage of the present invention is to provide a project management method, wherein the project management method has a resource view be built for at least a resource, which adds the data of the resource into the resource view, such that the resource view can have various data of the resources added, so as for achieving highly efficient management of the resources.

Another advantage of the present invention is to provide a project management method, wherein the project management method allows comparison between the project view and the resource view so as for selecting suitable resources for the project.

Another advantage of the present invention is to provide a project management method, wherein the project management method includes analyzing resource demand for the project and calling the resources that meet the resource demand from the resource view to work for the project.

Another advantage of the present invention is to provide a project management method, wherein the project management method includes determining at least an affair of the project according to the content of the project, wherein the project management method also includes analysis of the resource demand for the affair, so as for calling suitable resources for the affair.

Another advantage of the present invention is to provide a project management method, wherein when the project includes a plurality of the affairs, the project management method assigns a handling priority to each of the affairs, so as to determine the handling and processing sequence of the affairs.

Another advantage of the present invention is to provide a project management method, wherein the project management method allows a processing time of the project and the deadline of the affair to be determined, so as for ensuring the project be finished on schedule.

Another advantage of the present invention is to provide a project management method, wherein the project management method includes monitoring the condition of the resources through the resource view, so as for analyzing if the resources is available to respond to the call and work for the project.

Another advantage of the present invention is to provide a project management method, wherein the resource added in the resource view of the project management method includes human resource and hardware resource, which achieves total management of the resources.

Another advantage of the present invention is to provide a project management method, wherein the project management method utilizes the resource view to record the handling affairs of each of the human resources and the handling affairs of each of the hardware resources, so as to determine the duty modes of each of the resources.

Another advantage of the present invention is to provide a project management method, wherein the project management method includes analyzing the efficiency of the human resources handling the affairs, so as for calling suitable human resources for the project and ensuring the handling efficiency of the project.

Another advantage of the present invention is to provide a project management method, wherein the project management method includes recording the duty mode of the hardware resource, so as to determine if it is in use.

Another advantage of the present invention is to provide a project management method, wherein the project management method allows calling of the resources for coordinatingly handling the affairs in the project, which ensures the operating efficiency of the project.

Other advantages and features of the present invention can be fully achieved through the following detailed illustration and can be implemented through the manners, device, and combination thereof indicated by the appended claims.

According to an aspect of the present invention, a project management method of the present invention capable of achieving the above and other objects and advantages includes the following steps:

(A) Analyzing a resource demand of the project according to a project view of at least a project;

(B) Analyzing an available time of the resource according to a resource view of at least a resource; and

(C) Calling the resources to the project according to the resource demand and the available time of the resources.

According to an embodiment of the present invention, it further comprises the following step before the step (A):

Adding a content and a processing time of the project to the project view; and

Analyzing at least one affair of the project according to the content.

According to an embodiment of the present invention, the step (A) further comprises the step of:

Assigning a handling priority to each of the affairs; and

Determining a deadline for each of the affairs.

According to an embodiment of the present invention, the step (A) further comprises the following step:

Acquiring the processing time and the handling priority of each of the affairs from the project view; and

Determining the deadline of each of the affairs according to the processing time and the handling priority.

According to an embodiment of the present invention, the step (A) further comprises the following step:

Analyzing the resource demand of each of the affairs.

According to an embodiment of the present invention, it further comprises the following step before the step (B):

Adding at least a human resource to the resource view; and

Adding at least a hardware resource to the resource view.

According to an embodiment of the present invention, it further comprises the following step before the step (B):

Recording a start/stop time of the affair served by the resources; and

Calculating an average time for each of the human resources to handle the affair.

According to an embodiment of the present invention, the step (B) further comprises the step of:

Adding a duty mode of each of the resources to the resource view.

According to an embodiment of the present invention, the step (C) further comprises the step of:

Selecting the resource that meets the resource demand of the affairs; and

Analyzing the available time of the resources.

According to an embodiment of the present invention, the step (C) further comprises the step of:

Analyzing the available time of the human resource according to the duty mode and the average time for the human resource to handle the affair; and

Analyzing the available time of the hardware resources according to the duty mode of the hardware resources.

According to an embodiment of the present invention, the step (C) further comprises the step of:

Determining if the resources are capable of accomplishing the handling of the affairs before the deadlines; and

Calling the resources to serve for the affairs according to the results of the determination.

According to an embodiment of the present invention, it further comprises the following step after the step (C):

Monitoring the progress of each of the affairs of the project; and

Recording the work data of each of the affairs of the project; and

Adjusting the affairs monitored according to the handling priority.

According to an embodiment of the present invention, the step (A) further comprises the step of:

Analyzing a detail of the affair based on the work data of the affair;

Determining the handling priority for the detail of each of the affairs;

Determining the deadline for each of the details; and

Analyzing the resource demands by the detail of each of the affairs.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a project view of a project management method according to a preferred embodiment of the present invention.

FIG. 2 is a perspective view of a resource view of the project management method according to the above preferred embodiment of the present invention.

FIG. 3 is a step diagram of the project management method according to the above preferred embodiment of the present invention.

FIG. 4 is another step diagram of the project management method according to the above preferred embodiment of the present invention.

FIG. 5 is another step diagram of the project management method according to the above preferred embodiment of the present invention.

FIG. 6 is another step diagram of the project management method according to the above preferred embodiment of the present invention.

FIG. 7 is another step diagram of the project management method according to the above preferred embodiment of the present invention.

FIG. 8 is another step diagram of the project management method according to the above preferred embodiment of the present invention.

FIG. 9 is a perspective view of the project view of the project management method after at least a resource is called to at least a project according to the above preferred embodiment of the present invention.

### DETAILED DESCRIPTION OF THE PREFERRED EMBODIMENT

The following description is disclosed to enable any person skilled in the art to make and use the present invention. Preferred embodiments in the following are examples only and person skilled in the art can come out with other obvious alternatives. The general principles defined in the following description would be applied to other embodiments, alternatives, modifications, equivalents, and applications without departing from the spirit and scope of the present invention.

Those skilled in the art should understand that in the disclosure of the present invention, terms such as “longitudinal,” “lateral,” “upper,” “lower,” “front,” “back,” “left,” “right,” “perpendicular,” “horizontal,” “top,” “bottom,” “inner,” “outer,” etc., which indicate directions or positional relations are based on the directions or positional relations demonstrated in the figures and only to better describe the present invention and simplify the description, rather than to indicate or imply that the indicated device or element must be applied to a specific direction or be operated or constructed in a specific direction. Therefore, these terms shall not be considered limits of the present invention.

It is understandable that terminologies of “a” or “an” should be interpreted as “at least one” or “one or more.” In other words, in one embodiment, the quantity of an element can be one, but in another embodiment, the quantity of the element can be several. Hence, the terminologies of “a” or “an” shall not be considered as a limit of quantity.

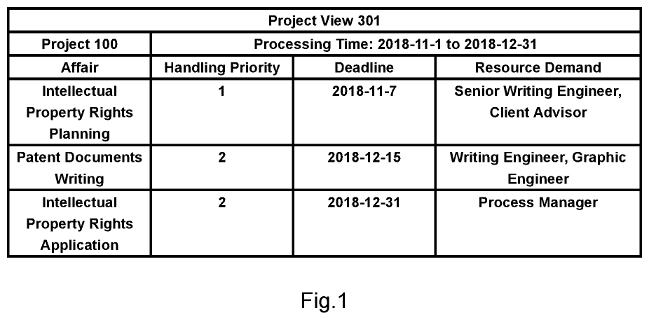

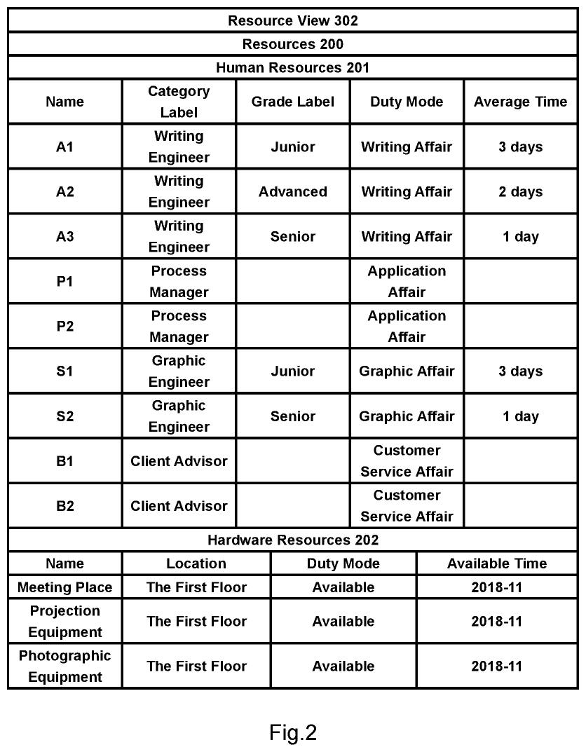

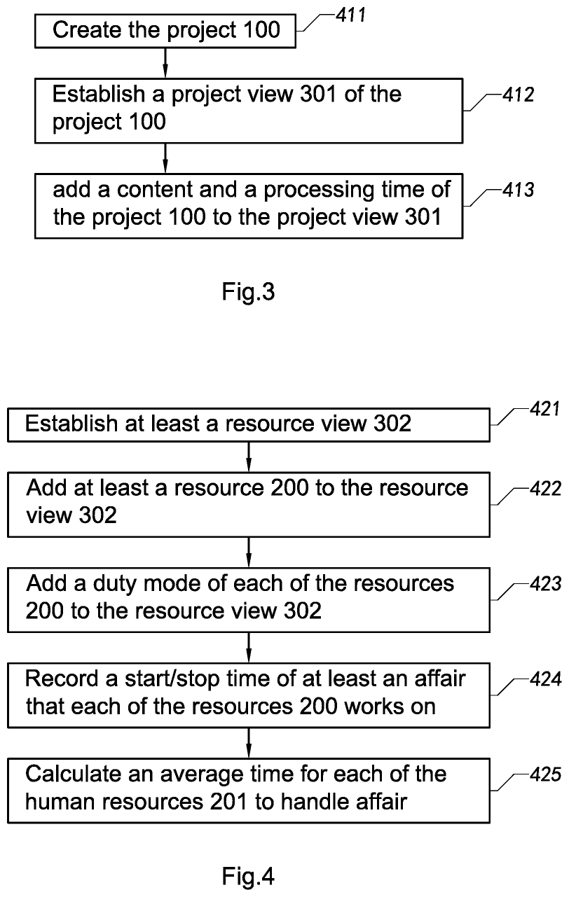

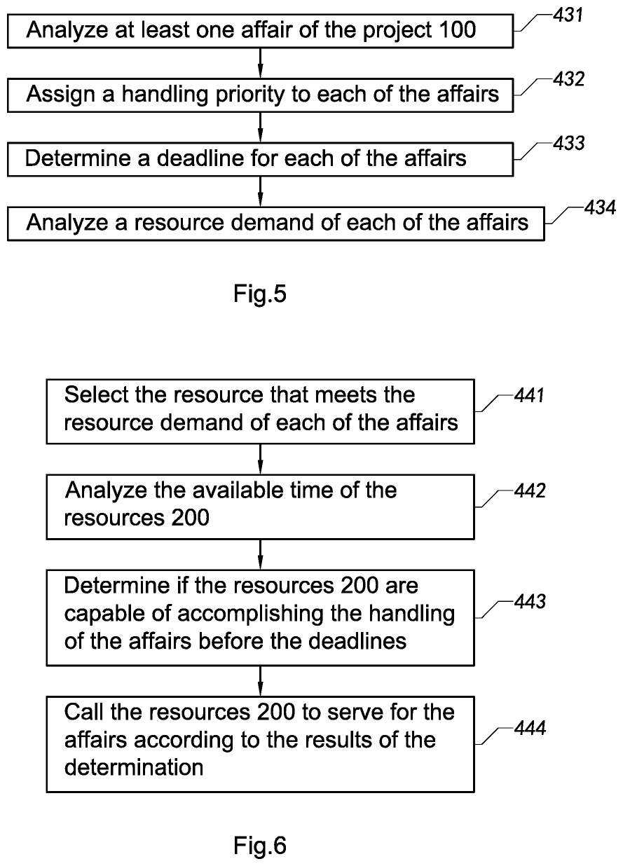

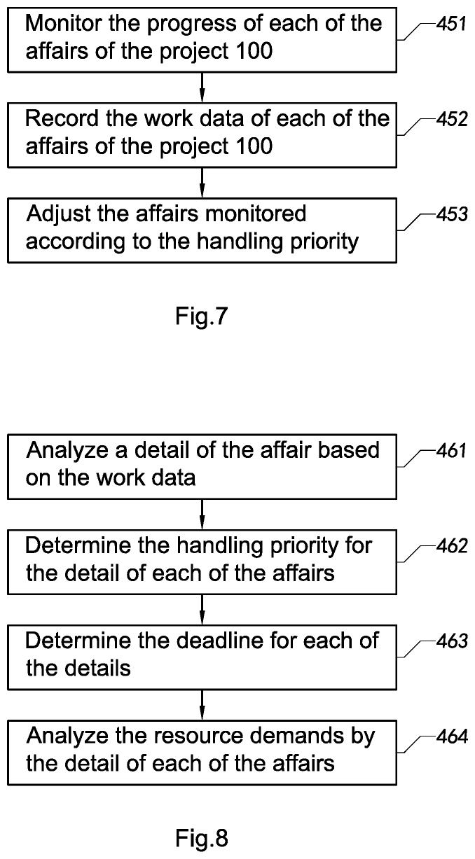

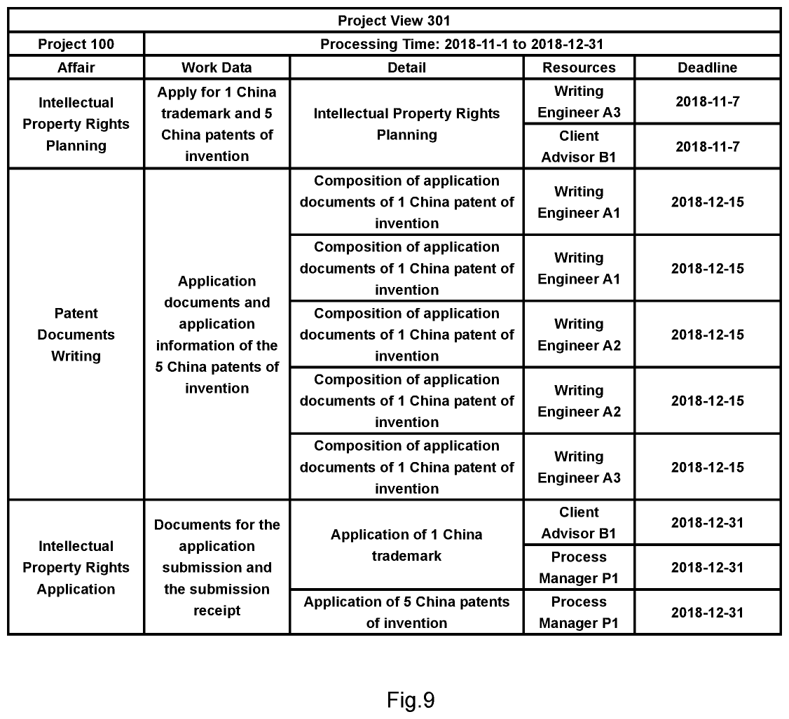

The present invention provides a project management method and FIGS. 1-9 disclose a preferred embodiment of the present invention. The present invention provides a project management method, which is utilized in the field of intellectual property rights and managing projects of intellectual property rights. The project management method manages at least a project 100 and at least a resource 200 for handling the project 100. The project management method includes analyzing the demand of the project 100 and the duty mode of the resources 200, so as for calling suitable resources 200 to serve for the project 100 based on the demand of the project 100.

The project management method comprises a step 411: create the project 100. In the step 411, it creates the project 100 through acquiring the information of the project 100. The information of the project 100 includes but not limited to the client of the project 100, the name of the project 100, the responsible personnel of the project 100, the content of the project 100, and etc. The information of the project 100 can be acquired through at least an input terminal. When the user inputs the information of the project 100 through the input terminal, the step 411 will be executed to acquire the information of the project 100 and to create the project 100.

The user inputs information of a new project of the client through the input terminal, which includes the client of the new project and the content of the new project, including planning, composition, and application of the intellectual property rights of a new product. The step 411 is utilized to create the project 100 for the client.

The project management method further comprises a step 412: establish a project view 301 of the project 100. The information of the project 100 is added into the project view 310. It establishes the project view 301 of the project 100 through integrating the information of the project 100 in the step 412. Present the information of the project 100 through the project view 301

The project management method further comprises a step 413: add a content and a processing time of the project 100 to the project view 301. In the step 413, it adds the content of the project 100 that has to be handled and the processing time of the project 100 into the project view 301. The project 100 is processed within the processing time and the content of the project 100 are preferably handled and finished within the processing time. In the above application scene of the present invention, the processing time of the project 100 is 2018-11-1 to 2018-12-31.

It is worth mentioning that the user may modify the information of the project 100. Then it can acquire the modified information of the project 100 through the step 411 and add the modified information of the project 100 into the project view 301 through the step 412. In other words, the content of the project view 301 can be updated based on the modification of the user. Similarly, the content and the processing time of the project 301 can both be modified.

The project management method also manages the resources 200. The project management method comprises a step 421: establish at least a resource view 302. The project management method manages the resources 200 through the resource view 302.

The project management method further comprises a step 422: add at least a resource 200 to the resource view 302. The resources 200 will be added into the resource view 302 and the resource view 302 will present the resources 200 for managing the resources 200.

The content of the resources 200 being added into the resource view 302 includes but not limited to the names, categories, undertaken roles, and etc. of the resources 200.

The resource 200 comprises at least a human resource 201 and at least a hardware resource 202. The human resources 201 are personnel who have a certain abilities and who have been recorded in the management system of the project. The hardware resources can be embodied as, including but not limited to, venues, facilities, devices, and etc. for handling the project 100, such as meeting rooms, office supplies, cameras, projectors, printers, computers, and etc.

The human resources 201 are further sorted by personnel category and handling ability. The categories of the human resources 201 include process manager, patent engineer, graphic engineer, client advisor, and etc. The human resources 201 are divided into different grades based on their handling ability. For example, the patent engineers are divided into senior writing engineers, advanced engineers, and junior engineers based on their case handling abilities.

Each of the human resources is assigned a category label. The category label 2011 labels the category of each of the human resources 201, representing the role of each of the human resources 201. When the human resources 201 under a category have to be divided into grades based on their handling ability, the human resources 201 under that category will be assigned a grade label. The grade label marks the handling ability of the human resource 201.

When the resource view 302 is added into the human resources 201, the names, the category labels, and the grade labels of the human resources 201 are all added into the resource view 302.

When the hardware resources 202 are added into the resource view 302, information of the hardware resources 202 should also be added into the resources view 302 so as for identifying each of the hardware resources 202. The information of the hardware resources 202 includes but not limited to the names, locations, and etc.

In the step 422, both the human resources 201 and the hardware resources 202 are added into the resources 200 of the resource view 302. In addition, both the information of the human resources 201 and the information of the hardware resources 202 are added into the resource view 302 as well. The information of the human resources 201 includes but not limited to the names, the category labels, the grade labels, and etc. of each of the human resources. The information of the hardware resources 202 includes but not limited to the names, locations, and etc. of the hardware resources.

In an application scene of the present invention, the resources 200 being added into the resource view 302 include the human resources 201 and the hardware resources. The human resources 201 include A1, A2, and A3 whose category label is writing engineer, P1 and P2 whose category label is process manager, S1 and S2 whose category label is graphic engineer, and B1 and B2 whose category label is client advisor.

The human resources whose category label is writing engineer are then divided into different grades according to their handling ability. Specifically, the grade label of writing engineer A1 is junior, the grade label of writing engineer A2 is advanced, and the grade label of writing engineer A3 is senior.

The project management method further comprises a step 423: add a duty mode for each of the resources 200 to the resource view 302. The information of whether each of the resources 200 is handling affairs has to be added in to the resource view 302. Specifically, both the affairs being handled by the human resources 201 and the affairs being assigned and waiting for handling have to be added into the resource view 302. In the above application scene of the present invention, the duty modes of each of the human resources 201 are added into the resource view 302.

The project management method further comprises a step 424: Record a start/stop time of at least an affair that each of the resources 200 works on. When the resources 200 are assigned the affairs, the resource view 302 will record the affairs served by the resources 200. When the resource view 302 monitors that the resource 200 has started to work on the affair, the resource view 302 will record the start time that the resource starts to work on the affair. When the resource view 302 monitors that the resource 200 has completed the affair, the resource view 302 will record a stop time that the resource completed the affair. The start/stop time of the affairs that the resources work on are recorded on the resource view 302. The start/stop time that each of the human resources 201 handles the affairs is recorded on the resource view 302.

The project management method further comprises a step 425: calculate an average time for each of the human resources 201 to handle affair. The history data is the data of the start/stop time that each of the human resources 201 handles the affairs. The history data is recorded in the resource view 302. In the step 425, it acquires the history data of each of the human resources 201 from the resource view 302, so as to calculate the average time for each of the human resources to handle the affair according to the start/stop time of each of the human resources handling the affair. It utilizes the step 425 to obtain the time cost for each of the human resources 201 to handle the affairs.

The project management method is utilized to analyze the newly created project 100 to obtain a resource demand of the project 100. The project management method includes analyzing at least an affair of the project 100 that has to be handled and analyzing the resource demand based on the actual affair.

The project management method comprises a step 431: analyze at least an affair of the project 100. It has to determine which affairs should be generated in the operation of the project 100 and be handled and processed. In the step 431, specific affairs included by the project 100 are analyzed according to the content to be handled in the project 100. The affairs are specific matters that have to be handled in the operation of the project 100.

In the step 431, the affairs that have to be handled during the process of the project 100 are determined through analyzing the content of the project 100. In the above application scene of the present invention, according to the project view 301, the content of the project 100 includes intellectual property rights planning, patent document composition, and intellectual property rights application for the new product of the client.

The step 431 is executed to determine that the affairs of the project 100 include intellectual property rights planning, patent document composition, and intellectual property rights application. Here, the composition of the patent documents can be divided into different specific affairs according to the quantity of the patent case to be written. The intellectual property rights application may also be divided into different specific affairs according to the differences of the content of the intellectual property rights cases that have to be submitted.

Specifically, the step 431 is executed to determine the affairs included by project 100 are: intellectual property rights planning, patent document writing affair, and intellectual property right application affair. Here, the quantity of the patent document writing affair is determined based on the quantity of the patent case determined in the intellectual property rights planning. The intellectual property right application affair must be determined based on the contents and product types were determined by the application demand of the intellectual property rights planning.

It is worth mentioning that after the execution of the step 431, the affairs of the project 100 and the specific matters of the affairs that have to be handled are added into the project view 301.

The project management method further comprises a step 432: determine a handling priority for each of the affairs. It analyzes the order of handling the affairs according to the content of the affairs of the project that have to be handled, so as to determine the handling priority of each of the affairs. The arrangement of the resources 200 and the handling of the affairs must be processed based on the order determined by the handling priority.

Because there are processing sequence for the handling of the intellectual property rights planning affair, the patent document writing affair, and the intellectual property right application affair, it has to process the intellectual property rights planning affair first, so as to determine the content of the patent document writing affair. Specific types and quantities of the intellectual property rights that have to be applied in the intellectual property right application affair have to be determined and handled after the intellectual property rights planning. Hence, the calling of the resources 200 of the project 100 has to be arranged and processed based on the processing sequence of the affairs in the project 100.

Accordingly, it has to call the resources 100 to serve for the intellectual property rights planning affair, so as to determine the actual content of the patent document writing affair and the intellectual property right application affairs.

The project management method further comprises a step 433: determine a deadline for each of the affairs. In the step 433, it determines the deadline of each of the affairs based on the content of the affair required to be handled and the processing time of the project 100 acquired from the project view 301. The step 433 is executed to conduct a time limit management of the affairs, so as to ensure that the content of the project 100 are handled and finished within the processing time.

The project management method comprises a step 434: analyze a resource demand for each of the affairs. In the step 434, the resource demand of each of the affairs is analyzed according to the actual content of each of the affairs. The step 434 is executed to acquire specific matters of the affairs that have to be handled from the project view 301 to analyze the resource demand of the affairs. It is worth mentioning that it acquires the deadline of the affair from the project view 301 and combines it with the deadline to analyze the resource demand of the affair.

It analyzes the resource demand according to the actual content of the affair. In the above application scene of the present invention, the project view 301, as illustrated in FIG. 1, the affairs of the project 100 include intellectual property rights planning affair, patent document writing affair, and intellectual property right application affair. According to the handling priority determined in the step 432, the intellectual property rights planning affair must be handled first. According to the step 433, it determines that the deadline of the intellectual property rights planning is November 7th, the deadline of the patent document writing affair is December 15th, and the deadline of the intellectual property right application affair is December 31st. Through the step 434 it analyzes and finds out that the intellectual property rights planning affair requires writing engineers and client advisors to handle and needs to utilize a meeting place for a planning conference to take place. Hence, it executes the step 434 to determine that the resource demand for the intellectual property rights planning affair includes the human resources 201 and the hardware resources 202.

Further, in the step 434, a grade requirement of the human resources 201 for handling the affair is analyzed. Then it determines the grade labels that the human resources 201 should have according to the contents of the affairs that have to be handled for responding the grade requirements of the affairs. The intellectual property rights planning affair requires patent engineers whose grade label is senior. The grade requirement of the human resource 201 of the affair is senior.

It is worth mentioning that after the step 434 is executed, the resource demands of the affairs will be added into the project view 301. The project view 301 presents the affairs of the project 100 and the resource demand of each of the affairs.

The step 432 further comprises a step 45: calling the resources 200 according to the conditions of the resources 200 and the resource demand of the project 100. The step 441 is executed to compare the conditions of the resources 200 and the resource demand of the project 100 and to call suitable resources to serve for the project 100.

The project management method further comprises the following steps:

441: Select the resource that meets the resource demand of the affairs;

442: Analyze the available time of the resources 200;

443: Determine if the resources 200 are capable of accomplishing the handling of the affairs before the deadlines;

444: Call the resources 200 to serve for the affairs according to the results of the determination.

Specifically, in the step 441, the resource demand of the project 100 includes the resource demand of each of the affairs. It selects the resources that meet the resource demand from the resources 200 according to the resource demand of each of the affairs. The step 441 is executed to select resources 200 that meet the resource demand of each of the affairs from the resources 200 based on the resource demand of each of the affairs of the project 100. The selected resource 200 comprises the human resource 201 and the hardware resource 202.

In the step 442, it analyzes the available time of the selected resources 200. Specifically, analyze the available time of the human resources 201. Here, the human resources 201 refer to the human resources 201 selected through the step 441. Acquire the duty modes of the human resources 201 from the resource view 302 and analyze the available time of the human resources 201.

In the step 425, the average time for the human resources 201 to handle the affairs are calculated. The average time that the human resources 201 handle the affairs are added into the resource view 302. In the step 442, it analyzes the available time of the human resources 201 according to the duty modes of the human resources 201 and the average time for each of them to handle the affairs recorded in the resource view 302.

The step 442 comprises analyzing the available time of the hardware resources 202 according to the duty mode of the hardware resources 202.

In the above application scene of the present invention, it determines the available time of the human resources 201 and the available time of the hardware resources 202 that meet the resource demand according to the resource view 302.

Specifically, the step 441 is executed to select the resources 200 that meet the resource demand of the intellectual property rights planning affair. Namely, the senior writing engineers and client advisors who meet the resource demand of the human resources 201 and the meeting place as the hardware resources 202 are selected according to the resource demand of the intellectual property rights planning affair.

Execute the step 442: analyze the available time of the resources. It analyzes the available time of the resources according to the resources 200 selected in the step 441. Acquire the average time to handle the affair and the duty modes of the human resources 201 from the resource view 302. It further calculates the remained available time of the human resources 201 under current duty mode according to the average time for the human resources to handle the affairs. Specifically, it calculates the available time of the senior writing engineer A3 and the client advisors B1 and B2. In the step 442, it analyzes the available time of the hardware resources 202. Namely, it analyzes the available time of the meeting place

Execute the step 443 to determine if the human resources 201 are capable of accomplishing the handling of the affair before the deadline. It determines if the senior writing engineer A3 and the client advisors are capable of finishing the intellectual property rights planning affair before the deadline thereof. Execute the step 443 to determine if the hardware resources 202 will be available by the deadline. Namely, it determines if the available time of the meeting place allows the human resources 201 to utilize it before the deadline.

The step 444 is executed to, according to the determination of the step 443, call the resources 200 that can finish the affair before the deadline to serve for the affair. Based on the determination of the step 443, it recognizes that the available time of the senior writing engineer A3 and the client advisor B1 are earlier than the deadline of the intellectual property rights planning affair and the available time of the meeting place is earlier than the deadline of the intellectual property rights planning affair. Then the step 444 is executed to call the senior writing engineer A3 and the client advisor B1 to serve for the intellectual property rights planning affair. In the step 444, it records the resources 200 called in the project view 301 of the project 100. The resources 200 called for the intellectual property rights planning affair are recorded as the senior writing engineer A3 and the client advisor B1. It applies to the step 444 to update the duty modes of the resources 200 being called and utilized. It updates the duty modes of the senior writing engineer A3 and client advisor B1 and adds the intellectual property rights planning affair of the project 100 into the duty modes. It real time updates the project view 301 and the resource view 302, so as to accurately manage the project 100 and the resources 200.

The project management method further comprises a step 451: monitor the progress of each of the affairs of the project 100. In the step 451, it monitors the progress of each of the affairs of the project 100. In the step 451, it monitors the progresses of the called resources 200 handling the affairs. Specifically, in the above application scene of the present invention, it monitors the progresses of the senior writing engineer A3 and the client advisor B1 handling the intellectual property rights planning affair.

The project management method further comprises a step 452: record the work data of each of the affairs of the project 100. The step 451 is executed to monitor the progress of each of the affairs of the project 100, while the step 452 is executed to record the work data produced in the handling processes of the affairs of the project 100. In the above application scene of the present invention, the step 452 is executed to record the work data produced when the senior writing engineer A3 and the client advisor B1 were handling the intellectual property rights planning affair. The work data include intellectual property rights planning for the client, which, in detail, requires one China trademark application and five China patents of invention applications for the product of the client. The work data produced by the intellectual property rights planning affair are recorded in the project view 302.

The project management method further comprises a step 453: adjusting the affairs being monitored according to the handling priority. In the step 453, when one of the affairs of the project 100 was accomplished, it will automatically adjust the monitoring object according to the handling priority of the affairs, to monitor the next affair that has to be handled. When the next affair starts to be handled, the step 452 will then be executed to record the work data of the affair on the project view 301.

When the work data of the intellectual property rights planning affair are produced, there is patent document writing affair to be handled and processed. The step 434 is executed again to analyze the resource demand of the patent document writing affair. Specifically, in the step 434, it calls the work data of the demand of the patent document writing affair from the intellectual property rights planning affair of the project view 301, so as to analyze and find out that the specific matters that have to be handled for the intellectual property rights writing affair include composition of the application documents of five China patents of invention. The deadline of the patent document writing affair is December 15th. The step 434 is then executed to analyze and find out that the resource demand for the composition of the application documents of the five China patents of invention include writing engineers.

Execute the step 441 to select the resources 200 that suit the writing affair of the patent documents to be the writing engineers from the resource view 302. When executing the step 442, it analyzes the available time of the writing engineers A1, A2, and A3. When executing the step 443 it analyzes the available time of the writing engineers under current duty modes. When executing the step 443, it determines if the writing engineers can finish handling the affair before the deadline according to the average handling time of the writing engineers. Specifically, it analyzes if the writing engineers A1, A2, and A3 are all capable of accomplishing the handling of the affairs before the deadlines.

The step 444 further comprises analyzing the affairs that the resources 200 are capable of undertaking. Specifically, in the above application scene of the present invention, the patent document writing affair is divided into compositions of the application documents of 5 China patents of invention and it analyzes which of the three engineers should specifically undertake the composition of application documents of which of the China patents of invention.

Specifically, the step 444 further comprises assigning the affair to the resource 200 based on the combined information of the average time for the resource to handle the affair, the available time of the resource 200, and the deadline of the affair. In the above application scene of the present invention, the average time for the writing engineers A1, A2, and A3 are respectively 3 days, 2 days, and 1 day, while the available time for the writing engineers A1, A2, and A3 to write the patent documents before the deadline are respectively 6 days, 4 days, and 1 day. Therefore, the composition of the application documents of two of the five China patents of invention are respectively assigned to the writing engineers A1 and A2 each, while the composition of the application documents of only one of the five China patents of invention is assigned to the writing engineer A3.

After the process of the step 441 to the step 444, the resources 200 for the patent document writing affair have been called and the resources 200 have started to handle the affair.

When executing the step 451, it monitors the progresses of the writing affairs of the five China patents of invention of the patent document writing affair. The step 452 is executed to record the work data generated during the handling process of the patent document writing affair. Namely, it records the application documents of the five China patents of invention written by the writing engineers and the application information of each of the patent inventors, applicants, and etc.

The step 452 is executed to handle the intellectual property right application affair. Through the step 451 to the step 452, it monitors the progress of the intellectual property rights planning affair and acquires the work data of the intellectual property rights planning affair, which includes applications of one China trademark and five China patents of invention. The application of China trademark is part of the work data required by the intellectual property right application affair. The intellectual property right application affair requires applying for 1 China trademark and 5 China patents of invention. The five China patents of invention need to be written by writing engineers, while the one China trademark can be submitted right after the application documents thereof are prepared.

The step 453 is executed to adjust the monitoring object of the affairs to the intellectual property right application affair and the patent document writing affair according to the same priority of the intellectual property right application affair and the patent document writing affair.

In other words, the affairs can be handled all at once or in a certain order depending on the specific matters that have to be handled. Each of the affairs, based on the specific matters that have to be handled, can further be divided into a plurality of independent affairs to be matched with the resources and handled solely.

According to another embodiment of the present invention, the project management method further comprises the step of:

461: Analyze a detail of the affair based on the work data;

462: Determine the handling priority for the detail of each of the affairs;

463: Determine the deadline for each of the details;

464: Analyze the resource demands by the detail of each of the affairs.

After the handling of the step 451 to the step 452, work data of the intellectual property rights planning affair were generated, wherein work data of the intellectual property rights planning affair is a reference for determining the patent document writing affair and the intellectual property right application affair. Then the step 453 is executed to determine that the patent document writing affair and the intellectual property right application affair will be processed after the intellectual property rights planning affair according to the handling priority of the patent document writing affair and the intellectual property right application affair. In the step 453, both the patent document writing affair and the intellectual property right application affair are monitored. The step 461 is executed to analyze the details of the intellectual property right application affair and the patent document writing affair according to the work data, wherein the detail of the patent document writing affair is composition of the application documents of five China patents of invention, while the detail of the intellectual property right application affair is application of one China trademark and application of the five China patents of invention.

The step 462 is executed to determine that the application documents of the five China patents of invention and the application of the one China trademark in the details can be handled simultaneously without affecting each other, but the application of the five China patents of invention has to be handled after the composition of the application documents of the five China patents of invention was finished. Namely, there will be handling priority for each of the details.

The step 463 is executed to determine the deadline of each of the details according to the deadline of the affairs and the handling priority of the details.

The step 464 is executed to analyze the resource demands by each of the details. Specifically, it analyzes and finds out that the resource demand for the composition of the application documents of the five China patents of invention is writing engineers and graphic engineers, the resource demand of the detail of the application of the one China trademark is a client advisor and a process manager, and the resource demand of the application of the five China patents of invention is a process manager.

After the details of each of the affairs and the corresponding resource demands were produced through the step 461 to the step 464, the step 441 to the step 444 can be executed to call the resources 200 for the details.

Execute the step 441 to select the resources 200 that suit the writing affair of the patent documents to be the writing engineers and the graphic engineers from the resource view 302. When executing the step 442, it analyzes the available time of the writing engineers A1, A2, and A3 and the graphic engineers S1 and S2. When executing the step 443, it analyzes the available time of the writing engineers and the graphic engineers under current duty modes. When executing the step 443, it determines if the writing engineers and the graphic engineers can finish handling the affair before the deadline according to the average handling time of the writing engineers and the graphic engineers. Specifically, it analyzes if the writing engineers A1, A2, and A3 and the graphic engineer S2 are all capable of accomplishing the handling of the affairs before the deadlines.

The step 444 further comprises analyzing the affairs that the resources 200 are capable of undertaking. Specifically, in the above application scene of the present invention, the patent document writing affair is divided into compositions of the application documents of 5 China patents of invention and it analyzes which of the three writing engineers should specifically undertake the composition of application documents of which of the China patents of invention. It is worth mentioning that there is only one of the graphic engineers meeting the resource demand and deadline, so s/he has to serve for the composition of the application documents of the five China patents of invention.

Specifically, the step 444 further comprises assigning the affair to the resource 200 based on the combined information of the average time for the resource to handle the affair, the available time of the resource 200, and the deadline of the affair. In the above application scene of the present invention, the average time for the writing engineers A1, A2, and A3 are respectively 3 days, 2 days, and 1 day, while the available time for the writing engineers A1, A2, and A3 to write the patent documents before the deadline are respectively 6 days, 4 days, and 1 day. Therefore, the composition of the application documents of two of the five China patents of invention are respectively assigned to the writing engineers A1 and A2 each, while the composition of the application documents of only one of the five China patents of invention is assigned to the writing engineer A3. The graphic works of the applications of the five China patents of invention are all assigned to the graphic engineer S2.

After the process of the step 441 to the step 444, the resources 200 for the detail of the application document composition of the five China patents of invention of the patent document writing affair have been called and the resources 200 have started to handle the affair.

After the detail and the resource demand of the China trademark application of the intellectual property right application affair are produced through the step 461 to the step 464, the step 441 to the step 444 can be executed to call the resources 200 for the detail of the China trademark application. The step 441 is executed to select process managers P1 and P2 and client advisors B1 and B2 as the resources 200 meeting the resource demand. The step 442 is executed to analyze the available time of the process managers P1 and P2 and the client advisors B1 and B2. Then the step 443 is executed to determine if the available time of the process managers P1 and P2 and the client advisors B1 and B2 is prior to the deadline of the China trademark application. When the available time of the process manager P1 and the client advisor B1 is prior to the deadline, the step 444 will be executed to call the process manager P1 and the client advisor B1 to be the resources 200 for the China trademark application.

The process manager P1 and the client advisor B1 handle the China trademark application affair. The step 451 to the step 452 are executed to monitor the progress of the detail of the affair.

By executing the step 451 to the step 452 to monitor the progress of the compositions of the application documents of each of the China patents of invention of the patent document affairs, it determines that the compositions have been finished and records the accomplishment of the compositions of the application documents of the five China patents of invention. When the step 453 is then executed, it monitors the progresses of the application affairs of the five China patents of invention of the intellectual property right application affair.

The step 461 to the step 464 are executed to call the resources 200 to handle the application of the five China patents of invention. In the step 461, it acquires the work data of the patent document writing affair, obtains the application documents of the five China patents of invention, and determines the detail to be application of five China patents of invention.

The handling priorities of the application of the five China patents of invention are the same in the analysis of the execution of the step 462. The step 463 is executed to analyze and find that the deadlines of the five China patents of invention are the same. Then the step 464 is executed to analyze and find that the resource demand of the application of the five China patents of invention is a process manager.

The step 441 to the step 444 are executed to call Process Manager P1 to handle the application affair of the five patents of invention. The step 451 and the step 452 are executed to monitor the progress of the application affair of the five patents of invention and to record the work data produced when handling the application affair of the five patents of invention, such as the application documents, submission receipt, and etc.

In the step 451, when it monitors and finds that all the details and the affairs of the project 100 are handled and finished, the operation of the project 100 will be finished.

It utilizes the project management method to manage the overall operation of the project 100 to define the contents that have to be handled in the project 100 as the affairs and to coordinate and manage the affairs according to the handling priority. The calling and arrangement of the resources 200 are conducted based on the combined information of the deadlines of the affairs and the handling ability of the resources 200.

It is worth mentioning that the numbers of the steps in the present invention are only for marking the steps, rather than referring to or implying the execution order of the steps.

Those skilled in the art shall understand that the above mentioned embodiments of the present invention in the descriptions and figures are to give examples, but to confine the present invention. Objectives of the present invention are completely and effectively implemented. Notions of the functions and structures of the present invention have been shown and described in the embodiments, whereas implementations of the present invention may have modifications or changes in any ways without going against the above notions.

What is claimed is:

1. A project management method, comprises the following steps:
(A) analyzing a resource demand of the project according to a project view of at least a project;
(B) analyzing an available time of the resource according to a resource view of at least a resource; and
(C) calling the resources to the project according to the resource demand and the available time of the resources.

2. The project management method, as recited in claim 1, further comprising the following steps before said step (A):
adding a content and a processing time of the project to the project view; and
analyzing at least one affair of the project according to the content.

3. The project management method, as recited in claim 2, wherein said step (A) further comprises the following steps:
assigning a handling priority to each of the affairs; and
determining a deadline for each of the affairs.

4. The project management method, as recited in claim 3, wherein said step (A) further comprises the following steps:
acquiring the processing time and the handling priority of each of the affairs from the project view; and
determining the deadline of each of the affairs according to the processing time and the handling priority.

5. The project management method, as recited in claim 3, wherein said step (A) further comprises the step of:
analyzing the resource demand of each of the affairs.

6. The project management method, as recited in claim 1, further comprising the following steps before said step (B):
adding at least a human resource to the resource view; and
adding at least a hardware resource to the resource view.

7. The project management method, as recited in claim 1, further comprising the following steps before said step (B):
recording a start/stop time of the affair served by the resources; and
calculating an average time for each of the human resources to handle the affair.

8. The project management method, as recited in claim 2, wherein said step (B) further comprises the step of:
adding a duty mode of each of the resources to the resource view.

9. The project management method, as recited in any of claims 1-8, wherein said step (C) further comprises the following steps:
selecting the resource that meets the resource demand of the affairs; and
analyzing the available time of the resources.

10. The project management method, as recited in claim 9, wherein said step (C) further comprises the following steps:
analyzing the available time of the human resource according to the duty mode and the average time for the human resource to handle the affair; and
analyzing the available time of the hardware resources according to the duty mode of the hardware resources.

11. The project management method, as recited in claim 10, wherein said step (C) further comprises the following steps:
determining if the resources are capable of accomplishing the handling of the affairs before the deadlines; and
calling the resources to serve for the affairs according to the results of the determination.

12. The project management method, as recited in claim 11, further comprising the following steps after said step (C):
monitoring the progress of each of the affairs of the project; and
recording the work data of each of the affairs of the project; and
adjusting the affairs monitored according to the handling priority.

13. The project management method, as recited in claim 12, wherein said step (A) further comprises the following steps:
analyzing a detail of the affair based on the work data of the affair;
determining the handling priority for the detail of each of the affairs;
determining the deadline for each of the details; and
analyzing the resource demands by the detail of each of the affairs.
